(19) United States
(12) Patent Application Publication
(10) Pub. No.: US 2010/0202352 A1
(43) Pub. Date: Aug. 12, 2010

(54) SYSTEM, METHOD AND APPARATUS FOR ROUTE-OPTIMIZED COMMUNICATION FOR A MOBILE NODE NESTED IN A MOBILE NETWORK

(76) Inventors: Jun Hirano, Kanagawa (JP); Mohana Dhamayanthi Jeyatharan, Singapore (SG); Chan Wah Ng, Singapore (SG); Pek Yew Tan, Singapore (SG)

Correspondence Address: Dickinson Wright PLLC;James E. Ledbetter, Esq., International Square, 1875 Eye Street, N.W., Suite 1200, Washington, DC, 20006, US

(21) Appl. No.: 12/679,886

(22) PCT Filed: Sep. 24, 2008
(86) PCT No.: PCT/JP2008/002632

§ 371 Date: Mar. 24, 2010

(30) Foreign Application Priority Data
Sep. 28, 2007 (JP) 2007-254749

(51) Int. Cl. H04W 4/00

(52) U.S. Cl. 370/328

(57) ABSTRACT

In a future scenario where end to end route optimization protocol such as the Access Router Option protocol and Hierarchical Mobility Management protocol are implemented in the visiting mobile nodes, mobile routers and the mobility anchor points, routing sub-optimality may occur when visiting mobile node that is nested is trying to communicate with the correspondent node. To overcome such routing sub-optimality arising in this heterogeneous protocol scenario, this invention presents a primary mechanism where the registration at the mobility anchor point is such that the local care-of address associated with visiting mobile node and local care-of addresses associated with upstream mobile routers of the visiting mobile node can be obtained using a single access router option protocol type of recursive tracing mechanism. Such tracing is achieved by embedding a different type of address in the access router option based binding registration at the mobility anchor point.

### TECHNICAL FIELD

This invention relates to the field of telecommunications in a packet-switched data communications network. More particularly, it concerns providing an optimized route to a mobile node having an end-to-end route optimization protocol and hierarchical mobility management protocol implemented.

### BACKGROUND ART

Many devices today communicate with each other using the Internet Protocol version 6 (IPv6). In order to provide mobility support to mobile devices, the Internet Engineering Task Force (IETF) has developed the “Mobility Support in IPv6 (MIPv6)” [Non Patent Citation 1]. Mobility support is done in [Non Patent Citation 1] with an introduction of an entity at the home network known as a home agent (HA). Mobile nodes (MNs) register their care-of addresses that they obtain in foreign links with the home agents using messages known as Binding Updates (BU). This allows the home agent to create a binding between the home address, which is the long-term address obtained in the home link, and care-of address of the mobile node. The home agent is responsible to intercept messages that are addressed to the mobile node's home address, and forward the packet to the mobile node's care-of address using packet encapsulation (i.e. putting one packet as the payload of a new packet, also known as packet tunneling). In addition, MIPv6 also specifies a route optimization (RO) method when communicating with a correspondent node (CN). This RO mechanism allows the MN to perform a validated registration of its care-of address at CN so that MN and CN can communicate with each other using MN's care-of address, without having to go through the home agent. CN obtains a validated registration of MN's care-of address by means of Return Routability (RR) test that is initiated by MN. This Return Routability test provides a proof to the CN that the care-of address of MN is collocated with MN's home address. This RO mechanism is an optional mechanism and its benefits are obtained only when the CN has some functionality to support RO mechanism.

One problem with MIPv6 is that for a single change in network attachment, the MN needs to update one or more of its home agents and one or more of its correspondent nodes. This increases the signaling load injected into the network for fast moving MN. Moreover, the average hand-off establishment time with CN per change in network attachment is high as every single change in network attachment involves transmission of RR and BU messages. Thus, during a session associated with a flow or connection, considerable amount of time is allocated to hand-off establishment, which results in jitters and packet losses. Such jitters are detrimental for applications such as voice over IP (VoIP), multimedia and video streaming and packet losses are detrimental for flows that carry critical text information. Furthermore, packet losses decreases transmission control protocol (TCP) throughput when TCP is used for information critical data applications.

To address such issues of MIPv6, IETF has standardized a protocol called the hierarchical mobility management protocol version 6 (HMIPv6) disclosed in [Non Patent Citation 2]. HMIPv6 uses two types of care-of addresses and a new node called the Mobility Anchor Point (MAP). The basic principle is that the MN derives two care-of addresses at a new network it is attached to. One of the care-of addresses is called the Local care-of address (LCoA) which is the address obtained from the network MN is directly attached to. The other address is called the Regional care-of address (RCoA) and it is derived from the MAP's network prefix. The RCoA is the address the MN will use as the care-of address when communicating with CN and HA. Since MAP is preferably a fixed router placed higher up in the routing hierarchy, this RCoA does not change often. As long as the roaming MN is inside the network segment where the MAP info can be obtained, Regional care-of address does not change. In this protocol, for every change in network attachment, the hand-off establishment procedure is mostly with the MAP where the LCoA is registered. Only when the MN moves out of the MAP and hence the RCoA is changed, will there be simultaneous updates or hand-off establishments to MAP, CNs and HAs. Thus, on average, signaling load into network per change in network attachment is much less when compared to MIPv6. Furthermore, for every change in network attachment, the hand-off establishment time is less on average. This is because, majority of the time, hand-off is only associated with a simple LCoA registration at MAP which is placed at close proximity to the roaming MN. Thus the complexities such as jitters and packet losses discussed previously are much less here. This protocol is an accepted standard for nodes that want power saving for its flows and for nodes that carry flows that require stringent Quality of Service (QoS) parameters.

With the ever-increasing proliferation of wireless devices, it is foreseeable that a new class of mobility technology will emerge: network mobility, or NEMO, where a whole network of nodes changes its point of attachment in entirety. The IETF has developed a solution for basic network mobility support disclosed in [Non Patent Citation 3]. Here, it is specified that the mobile router (MR) when sending BU to home agent, will specify the network prefix, which the nodes in the mobile network are using. These are specified using special options known as Network Prefix Options to be inserted into the BU. These allow the home-agent to build a prefix-based routing table so that the home-agent will tunnel any packets sent to destinations with these prefixes to the care-of address of the mobile router.

When a MN is deeply nested in a NEMO, two types of problems arise. The first type of problems includes multiple encapsulation overhead for data and suboptimal routing for data. This is due to nested tunneling for the nested NEMO scenario. Multiple encapsulation results in delay of data packet due to the increase in packet size and may also further lead to packet fragmentation. Packet fragmentation may further result in data packet loss. Sub-optimal routing also leads to data packet delay, increase in network load and burdening the HAs with higher processing load.

The second type of problems includes the massive delay for layer three hand-off establishments for the deeply nested MN and the high signaling load injected into the network due to signaling overhead of RR and BU stream. This arises because when MN is deeply nested and if the change in network attachment and hence the care-of address obtained has to be updated to the CNs or HAs, there will be a massive delay in such registration due to the packets involved in hand-off registration being subjected to multiple encapsulations. As discussed previously, this increase in hand-off delay time will contribute significantly to the overall session or connection time of a flow carried by a fast moving MN, which results in jitters and packet losses. Furthermore, excessive hand-off establishment signaling by a MN during a given time affects other flows carried in the network as well.

To solve the first type of problems, there have been various proposals to what is known as a nested tunnel optimization in the relevant field of art. Particularly, [Non Patent Citation 4] discloses a solution known as the Access Router Option (ARO). This new option, called the Access Router Option, is used by the sender (i.e. mobile muter or mobile host) to inform the recipient (e.g. home agent or correspondent node) the primary global address of the access router the sender is attached to. After sending the binding update message with the access router option, the mobile node can then insert a special signal called the “direct-forwarding-request” signal to the data packet it sends out. This signal will cause upstream mobile access router to send binding updates of its own to the destination address. This process is repeated until the topmost mobile access router is reached. With all upstream mobile access routers sending binding updates to the destination, the destination can build a chain of mobile access routers the mobile node is attached to. This can be used to construct the extended Type 2 Routing Header, so that when the destination node wants to send a packet back to the mobile node, it can embed the packet with the routing header, and the packet will be routed directly to the mobile node via the chain of mobile access routers. This method is considered as an adequate method to provide end-to-end route optimization without trading off the security.

To solve the second type of problems and to partially solve the first type of problems, [Non Patent Citation 5] reveals a scheme where the design of the scheme tackles issues such as nested tunneling and Layer three (L3) hand-off establishment delay. This scheme attempts to improve hand-off efficiency and signaling overhead and provide reasonable end-to-end route optimization for a nested MN in a MAP environment. In this scheme, every MN (which is considered as a mobile host in this document) behaves as specified in HMIPv6. For every change in local network attachment, the MN will update its LCoA at the MAP and for every change in the RCoA or the MAP domain, the MN will update its CNs and HAs of the new RCoA. In this scheme, it is also assumed that the MR will operate as specified in the HMIPv6 protocol for the MN but will have slight modifications. The MR when it operates in the router mode will advertise the MAP option in its router advertisement (RA) to extend the MAP services to the MNs that are attached to it. Furthermore, in order to help the MAP trace the optimum path to reach a MN LCoA, the MRs will do a prefix scoped binding update (PSBU) at the MAP instead of the pure HMIPv6 type of registration. Suppose the MN is deeply nested behind some number of MRs, the binding cache at the MAP will have MN's LCoA, RCoA as well as the upstream MRs LCoAs, RCoAs and prefix of the MRs. To one skilled in the art it is well known how the MAP can use this prefix to locate all the LCoA associated with the MN's upstream MRs. Such tracing is possible because the MN's or MR's LCoA is derived from its access router's prefix.

When a data packet arrives at the MAP for a RCoA associated with the MN, MAP will first locate this RCoA. Then the MAP will find the corresponding LCoA associated with this RCoA in the binding cache entry (BCE). Following that the MAP will search for the prefix that matches this LCoA of MN. By doing this, MAP can find the location parameters of the direct mobile access router of MN and repeat such process until all the upstream MRs LCoAs can be obtained. Once such recursive tracing is done at the MAP, it will tunnel the data packet to the MN by inserting a routing header in the tunnel consisting of all the upstream MRs LCoAs. When MN sends a packet to the CN, as in HMIPv6, MN will first encapsulate the packet in a tunnel to the MAP. All the upstream MRs of MN, since it has a binding at the MAP, will further encapsulate the packet in separate tunnels to the MAP. The final effect of this scheme is that for incoming data packets, there will be a single tunnel from MAP with extended routing header. For outgoing data packet there will be multiple encapsulations from MN/MR to MAP in the wireless domain. It is important to understand that this protocol mainly attempts to improve hand-off and signaling for a MN deeply nested in a NEMO. When comparing this scheme to the ARO scheme as disclosed in [Non Patent Citation 4], it is important to appreciate that the ARO scheme provides better end-to-end RO. This is because in ARO, there is no tunnel in the wireless domain in the reverse direction, whereas there are multiple tunnels in the wireless domain in [Non Patent Citation 5]. In addition, for ARO, there is no tunnel in the forward direction.

From the above discussions it can be foreseen that in the future, different types of protocols may need to be implemented in the system in order to achieve the objectives of data flows, end terminals and networks. As far as data flows are concerned, the main objective will be to reduce delay, jitters and packet loss. The main objective of the network perceived QoS is to reduce the network load or more correctly the signaling load into the network. The MNs objective is to save power. Hence in order to combine all these objectives as a single goal, it is very likely that multiple protocols may need to be implemented in the system. A future MN may need to support different types of flows having different QoS needs. For example, the MN may carry some flows that require strict end-to-end RO and also some flows that are not strict about end-to-end RO. For flows that are not too strict about end-to-end RO the MN may need to consider improving signaling load injected into network and save power by reducing frequent binding updates. Thus, it is foreseeable that in the future different type of protocols needs to be implemented in a MN, MR, some key routers and CN.

To further illustrate the importance of such heterogeneous protocol operation, FIG. 1 shows a future scenario where some Internet Service providers (ISPs) may implement the MAP functionality while some may not. In such a case, it is obvious that different types of protocols are required. It is assumed that visiting mobile node (VMN) 10 is initially at position A and then moves to position B. When it is at position A, it cannot use the MAP services because the ISP it is situated does not have MAP functionality implemented. It is assumed that VMN 10 has the ARO protocol implemented. VMN 10 is directly attached to MR 20 by wireless link 60 and MR 20 is directly attached to MR 21 via wireless link 61 and MR 21 is further attached to AR 30 via wireless link 62. Further it is assumed that VMN 10 is inside the mobile network (NEMO) 106, MR 20 is inside NEMO 107 and MR 21 is inside wireless access network 108. AR 30 is attached to the global communications network 100. Home Agents 50, 51 and 52 respectively denotes the home agents of VMN 10, MR 20 and MR 21. It is assumed that VMN 10 is communicating with CN 70. It is further assumed that CN 70 is an ARO enabled node and so are MR 20 and MR 21. In position A, all flows originating at VMN 10 or finishing at VMN 10 can enjoy bi-directional RO. In this case ARO mechanism is very useful because it provides a full end-to end RO. The only short fall is that for every movement of VMN 10 or upstream MR movement, the CN needs to be updated of the new care of address obtained. This in turn can drain quite a bit of power from terminals and increase signaling load into network.

Next, it is assumed that VMN 10 moves into position B. VMN 10 at position B is directly attached to AR 31 via access network 105 and uses the wireless link 63 to reach AR 31. In this position, the MAP 40 information can be reached at wireless access network 105. Nevertheless, the main problem is that the VMN 10 does not have HMIPv6 protocol implemented. Since the network topology at position B is not nested, ARO mechanism will not be triggered and VMN 10 will merely use MIPv6 to communicate with CN 70. It is understandable to one skilled in the art that ARO protocol is implemented as an extension to MIPv6 protocol at VMN 10. Due to VMN 10 operating in MIPv6 mode, there is definitely multitude of issues as discussed previously in the document. The movement of solely ARO implemented VMN 10, from position A to position B, clearly shows a scenario where ARO plus HMIPv6 heterogeneous implementation is useful in a single node.

Next, we consider node VMN 11. This node is assumed to have only the HMIPv6 protocol implemented in it. It is moving into a nested NEMO scenario as depicted at position C in FIG. 1 and is communicating with CN 70. In this scenario, VMN 11 is directly attached to MR 22 via wireless link 64 and it is embedded in NEMO 104. MR 22 is directly attached to MR 23 via wireless link 65 and embedded in NEMO 103 and MR 23 is directly attached to AR 32 via wireless link 66 and situated inside the wireless access network 102. The AR 32 can obtain the MAP option that is originated at MAP 41, which is placed high up in the router hierarchy and placed in the network 101. It is further assumed that the HAs of VMN 11, MR 22, MR 23 are respectively HA 53, HA 54 and HA 55.

Suppose the upstream MRs of VMN 11 only have the HMIPv6 functionality implemented, then, they may not send the MAP option in its RA. Thus, VMN 11 cannot enjoy HMIPv6 services and need to operate in MIPv6 mode. Moreover, MR 22 need to operate as in NEMO Basic mode disclosed in [Non Patent Citation 3]. In this case, it is well know to one skilled in the art that extreme sub-optimal routing and location management inefficiency will occur. If upstream MRs of VMN 11 does pass the MAP option in their Router Advertisements, VMN 11 can enjoy the HMIPv6 efficiency but the routing inefficiency problem will still remain. This is because the BCE at the MAP 41 lacks parameters to trace the LCoA of upstream MR of VMN 11. Each entry at the MAP 41 will be simple RCoA and LCoA entry. Thus the packet from CN 70 will arrive at MAP 41 and will initially get tunneled to a LCoA which is derived from a prefix allocated by MR 22's home agent. Because of this, the encapsulated packet at MAP 41 will reach HA of MR 22 in the internet and will be further tunneled to the MAP 41. Such tunneling to and forth from MAP will occur until the destination at the packet constructed at the MAP 41 points to LCoA of MR 23. This clearly shows inefficient routing in the forward direction. If some NEMO-HMIP RO mechanism as disclosed in [Non Patent Citation 5] is implemented in MRs and the MAP 41 in a scenario at position C, improvement in signaling efficiency and RO can be obtained. Nevertheless, when some flows in VMN 11 require very stringent delay requirements, it is essential for VMN 11 to implement an ARO type of end-to-end protocol, which does not have any tunneling procedure at all! Moreover, suppose MAP 41 is subject to failure, then it is important to have ARO mechanism implemented at VMN 11 and upstream MRs as the NEMO-HMIPv6 RO mechanism as disclosed in [Non Patent Citation 5] cannot provide RO for flows at VMN 11 in such a MAP failure event. From this discussion, it is clear that in the future it is foreseeable that ARO and HMIPv6 scheme is likely to be implemented in the system.

If both ARO and HMIPv6 protocols are implemented in MNs and MRs and the nodes are roaming in a MAP domain, it is important to see what happens to the data traffic when both ARO and HMIPv6 implementations are triggered at the mobile terminals. FIG. 2 shows the message sequence chart (MSC) of the data as well as signaling streams in a future ARO+HMIPv6 scenario. In FIG. 2, VMN 12 is nested behind MR 24, where MR 24 is directly attached to AR 33. It is also assumed that AR 33 is directly/indirectly attached to MAP 42. The home agent HA 56 is the home agent of MR 24 and HA 57 is the home agent of VMN 12. It is further assumed that VMN 12 is communicating with CN 71. It is assumed that VMN 12, MR 24, MAP 42, HA 56, HA 57 and CN 71 are all ARO enabled. It is also assumed that VMN 12, MR 24 and MAP 42 are ARO+HMLPv6 enabled and have both protocol stacks implemented in them. To further highlight some interoperation issues, next, detail signaling will be discussed in greater depth.

When MR 24 comes into the network of AR 33, it will receive RA 200 with the MAP option. It will then configure the LCoA as well as the RCoA and send a registration signaling 201 to MAP 42. After such bi-directional local registration, MAP 42 will have BCE as shown by 202. Following that, MR 24 will update its HA 56 with NEMO Basic type of registration using message 203 in FIG. 2. After such two way registration and acknowledgement signaling, the HA 56 will have a BCE as shown by 205. This registration message 203 to HA 56 will get encapsulated to MAP 42 at MR 24 and will get decapsulated at MAP 42 and further decapsulated message 204 will reach HA 56.

After such registrations, MR 24 will further send a RA 206 in its NEMO link. This RA will have ARO option and the MAP option. The ARO option will carry the home address of MR 24 and the MAP option will carry the global address of MAP 42. If VMN 12 processes the MAP option first, then it will subsequently configure two care of addresses. One is the RCoA from the MAP address prefix and another LCoA from the prefix advertised by MR 24, which is obtained from the home agent of MR 24. After this, if VMN 12 process the ARO option, the first of the series of signaling will be such that, VMN 12 may want to register with its local home agent which is MAP 42. Since the ARO protocol is triggered at VMN 12 after processing the ARO option, VMN 12 will use the ARO option when sending BU to the MAP. This ARO option will be inserted into the mobility header comprising the BU message.

This is shown as message 207. This message 207 will be further encapsulated at MR 24 in a tunnel to MAP and the encapsulated BU 208 will reach MAP 42. The MAP 42 will further update its binding cache (BC) entries 209 with the VMN 12 entry. The MAP 42 is also considered as ARO enabled and thus it will send a Binding Acknowledgement (BA) to VMN 12. The BA from MAP will be destined to the home address of MR 24 and it will also have a RH2 where the RH2 will have LCoA of VMN 12 and RCoA of VMN 12. The BA message 210 will initially reach HA 56. There the BA message will be tunneled to the RCoA of MR 24. This encapsulated message 211 will reach the MAP 42 as shown in FIG. 2. And, MAP 42 will look at the destination address, which is the RCoA of MR 24. Since the MAP 42 has an entry for this RCoA as shown in 209, MAP will further tunnel the BA packet to LCoA of MR 24. This tunneled message 212 will reach MR 24. Here, the message 212 will get decapsulted twice.

After decapsulation process, MR 24 will observe that the innermost packet has a destination address as the home address of MR 24. In that case, it will inspect the RH2 and change the destination to LCoA of VMN 12 and route the BA message 213 to the ideal recipient. After this, as disclosed in the ARO protocol specification, since the BA from a node is addressed to a node's home address, it is evident the binding for the home address of MR 24 is not available at MAP 42. In this case, MR 24 will start RR procedure with MAP 42 with the intention of binding its home address to its RCoA at MAP 42. It can be readily understood to one skilled in the art that once both protocols are activated at MR 24, as far as the ARO implementation is concerned, it will consider its RCoA as the external address it discloses to all its HAs and CNs. Since MR 24 has not engaged in a MR 24 HoA registration at MAP 42, such RR and BU will be triggered at MR 24.

MR 24 will construct a Home Test Init Message (HoTI) where the source address will be home address of MR 24. Hence MR 24 will encapsulate the HoTI packet in a tunnel to its HA 56. This tunnel source address will be RCoA of MR 24. To overcome ingress filtering in the access network, this HoTI will be further tunneled to MAP 42 at MR 24. This doubly encapsulated HoTI packet 214 will reach MAP 42 and will undergo a single level of tunnel decapsulation procedure. After that, a single encapsulated packet 215 will reach HA 56. There, the HoTI packet will be further decapsulated and the HoTI message 216 will finally reach the final intended recipient MAP 42. After transmitting the HoTI packet, the MR 24 will almost simultaneously send the Care-of Test Init (CoTI) message 217 to MAP 42. The CoTI message will have the source address as the RCoA of MR 24. Thus this CoTI message will be tunneled to MAP 42 and this is shown by message 217. After receiving these two HoTI/CoTI messages, MAP 42 will send the Home Test message (HoT) and Care of Test (CoT) message to MR 24. The HoT message will have the source as the MAP 42 and the destination as the home address of MR 24. This HoT message 218 will reach HA 56. Here, HoT will be tunneled to the RCoA of MR 24. This tunneled HoT message 219 will reach MAP 42. MAP will further refer to its BC entries 209 and further tunnel the HoT message to the LCoA of MR 24. This doubly encapsulated HoT message 220 will reach MR 24 and will be processed there.

Next, MAP 42 will send the CoT message to MR 24. The CoT message will be constructed such that MAIP address is the source address and the destination address is the RCoA of MR 24. This message will be further encapsulated in a single tunnel to LCoA of MR 24. This message 221 will reach MR 24. After getting the relevant RR tokens, MR 24 will form the signing key and send the BU registration message to MAP 42. This BU registration message will have source address as the RCoA of MR 24 and destination address as MAP 42 address. This BU packet will have the home address of MR 24 in the destination option header. Such bidirectional registration and acknowledgement is given by message 222. Once such BU registration is accepted at MAP 42, MAP 42 will update its BC entries and the BCE at MAP 42 will look like the one given by 223.

After VMN 12 does BU registration at MAP 42, VMN 12 may want to register with its own home agent HA 57. In this case, VMN 12 will use its RCoA as the source address to register with the HA 57. The ARO option will be inserted into the mobility header comprising the BU. This BU message will be further encapsulated in a tunnel to MAP 42. Since the VMN 12 has done an ARO binding at the MAP 42, VMN 12 will insert the NEMO forward hop-by-hop option (NEMO-FWD) into the tunnel header. When MR 24 receives this message 224 and inspects this hop-by-hop option, MR 24 will switch the source address to its RCoA and further tunnel the packet to MAP 42. This second tunnel inserted at MR 24 will have the LCoA of MR 24 as the source address and the MAP 42 address as the destination address. This doubly encapsulated message 225 will reach the MAP 42 and will go through two levels of decapsulation. Finally, the inner message 226 will be routed to HA 57.

Since this is an ARO type of registration where the ARO option has the HoA of MR 24, the BCE at HA 57 will look like the one shown by 227. After getting the BU from VMN 12, HA 57 will send its BA with the destination set to the home address of MR 24. This message 228 will be sent to the home network of MR 24 and the packet will be intercepted by HA 56 and will be tunneled to the RCoA of MR 24. This tunneled message 229 will reach MAP 42. There the MAP 42 will use BCE 223 and tunnel the packet to the LCoA of MR 24. This doubly encapsulated message 230 will reach MR 24 and will undergo two levels of decapsulation. After such decapsulation, MR 24 will inspect the destination address of the innermost packet. Since it is the home address of MR 24, MR 24 will further inspect the RH2. The next entry at the RH2 will be the RCoA of VMN 12. Thus, MR 24 will further tunnel the packet to its HA 56 and again to MAP 42. This doubly encapsulated packet 231 will reach MAP 42 and there it will be decapsulated once. After this, the message 232 will reach the home agent of MR 24 and will go through one more decapsulation process. After such decapsulation, the BA message 233 will reach MAP 42. MAP 42 will look at its BCE 223 to find the adequate entries to route the packet. MAP 42 will use ARO tracing mechanism to find the entries to reach the RCoA of VMN 12. The entries obtained from the ARO tracing are the LCoA of VMN 12 and RCoA of MR 24. Thus, MAP 42 will embed the packet in a tunnel where the destination address will be RCoA of MR 24. The tunnel will have a RH containing the LCoA of VMN 12 and RCoA of VMN 12.

After such single level of tunnel formation, MAP 42 will inspect the destination address of the packet to determine the routing path. Since the destination is the RCoA of MR 24, it will further check BCE 223 and it will find the relevant LCoA of MR 24. Thus the packet will be encapsulated twice at MAP 42 and this BA message 234 will reach MR 24. MR 24 will decapsulate this BA message 234 and will inspect the RH2. It will switch the destination address to LCoA of VMN 12 and will further route the BA message to LCoA of VMN 12. This message 235 with single level of encapsulation will reach VMN 12. From the BA message 230, the MR 24 will know that HA 57 does not have its home address entry registered there and MR 24 will trigger the normal RR, BU process to HA 57. This is shown as message 236. The details of the signaling packet structure and the details of routing paths are not explained in detail for the message 236. Nevertheless, for one skilled in the art this can be easily deducted and understood.

After such registration, the HA 57 BCE will be as shown by 237. It is interesting to note that the entries at HA 57 are all RCoAs and it can be seen that ARO and HMIPv6 combined operation is causing RCoA to be registered instead of LCoAs. After such binding establishment at HA 57, VMN 12 may now wish to establish route optimization with its CN 71. Thus, it will trigger the RR procedure. The HoTI message VMN 12 constructs with its home address as source address will be encapsulated twice as explained previously. This doubly encapsulated message 238 will be further tunneled at MR 24 to MAP 42 and this message 239 will reach MAP 42. At MAP 42, this message will undergo two levels of decapsulation and the singly encapsulated message 240 will reach VMN's home agent, which is HA 57. At HA 57, the HoTI will be fully decapsulated and the HoTI message 241 will reach CN 71. Following that, VMN 12 will send the CoTI message to CN 71. The inner packet of the CoTI message will have RCoA of VMN 12 as the source address. This CoTI message will be tunneled to MAP 42. Again as discussed previously, there will be a NEMO FWD option present in the outer tunnel. This single encapsulated message 242 will be further encapsulated at MR 24 and this double encapsulated message 243 will reach MAP 42. At MAP 42, this message will go through two levels of decapsulation and finally CoTI message 244 will reach CN 71. After successfully receiving HoTI and CoTI from VMN 12, CN 71 will send the respective HoT and CoT messages. These HoT, CoT messages and BU/BA are shown by message 245. Again to simplify the explanation, details of these messages are omitted.

After such registration, the CN 71 BCE is shown as 246. When MR 24 receives a BA addressed to its home address, it will trigger ARO type BU establishment with CN 71. This RR, BU and BA are shown as message 247 in the figure. After such signaling, the BCE at CN 71 is given as 248. Suppose VMN 12 wants to send a data packet to CN 71 it will check its binding list. The binding list will indicate that RCoA is revealed to CN 71 and an ARO type of registration took place at CN 71. The data packet constructed at VMN 12 will be further tunneled to the MAP 42 as the HMIPv6 stack is also active at VMN 12. Thus the data packet structure at VMN 12 is shown as 252. The outer tunnel will have source address as the LCoA of VMN 12 and destination address as the MAP 42 address. The outer tunnel will have the NEMO-FWD hop-by-hop option and will also have the destination option, which is the RCoA of VMN 12. This singly encapsulated message 249 will be further inspected at MR 24. MR 24 will look at the NEMO-FWD option and will see whether it has ARO type of registration using its home address (HoA) at the destination. Since MR 24 has such HoA registration at MAP 42, it will switch the source address to its RCoA. Again as in HMIPv6, it will tunnel the packet to the MAP 42. Thus at MR 24, the data packet will go through a second round of encapsulation. The data packet structure of the reconstructed packet at MR 24 is shown as 253. This doubly encapsulated packet 250 will reach MAP 42. MAP 42 will first decapsulate the outermost tunnel. When MAP 42 decapsulates the second tunnel, MAP 42 will do ARO tracing and will check whether the source address in the inner tunnel (MR 24 RCoA) is relevant. Since it is correct, as can be obtained when tracing for RCoA of VMN 12, MAP 24 will remove this inner tunnel as well and route the message 251 to the destination.

Next, when one considers the data packet sent from CN 71 to VMN 12, the data packet constructed at CN 71 will be such that the destination address will be RCoA of MR 24. The RH2 at CN 71 will have RCoA of VMN 12 and home address (HoA) of VMN 12. This data message 254 will reach the MAP 42 where it will be intercepted and subjected to tunneling. The MAP 42 will use its BCE 223 and tunnel the packet to LCoA of MR 24. This tunneled message 255 will reach MR 24 and will be subjected to decapsulation. MR 24 will swap the destination address with the RCoA of VMN 12 in the RH2 and will further tunnel the packet via its HA 56 and will further tunnel it to MAP 42 as in HMIPv6 operation. This doubly encapsulated message 256 will be subjected to single level of decapsulation at MAP 42. After that, message 257 will reach HA 56 and after decapsulation will again reach MAP 42. The MAP 42 will again use the BCE 223 and using two levels of tracing as explained previously will send the data packet to LCoA of MR 24. The first tunnel for message 259 will have RCoA of MR 24 as the destination and LCoA of VMN 12 and RCoA of VMN 12 in the routing headers. The second tunnel for message 259 will have LCoA of MR 24 as the destination. This data message will reach MR 24 where it will be decasulated once and MR 24 will swap the destination address to LCoA of VMN 12. Finally, the encapsulated data packet 260 will reach VMN 12 where it will be decapsulated and sent to upper layers.
Patent Citation 1: Hirano, J., Ng, C. W., et al., “Method and Apparatus for controlling packet forwarding, and communication node”, WIPO Patent Application Publication WO06129863A1, December 2006.
Patent Citation 2: Hirano, J., Ng, C. W., et al., “Method and Apparatus for controlling packet forwarding”, WIPO Patent Application Publication WO06129858A1, December 2006.
Patent Citation 3: Hirano, J., Ng, C. W., et al., “Method and Apparatus for controlling packet forwarding”, WIPO Patent Application Publication WO06129855A1, December 2006.
Non Patent Citation 1: Johnson, D. B., Perkins, C. E., and Arkko, J., “Mobility Support in IPv6”, Internet Engineering Task Force Request For Comments 3775, June 2004.
Non Patent Citation 2: Soliman, H., et. al., “Hierarchical Mobile IPv6 Mobility Management (HMIPv6)”, Internet Engineering Task Force (IETF) Request For Comments (RFC) 4140, August 2005.
Non Patent Citation 3: Devarapalli, V., et. al., “NEMO Basic Support Protocol”, Internet Engineering Task Force Request For Comments 3963, January 2005.
Non Patent Citation 4: C. Ng and J. Hirano, “Securing Nested Tunnels Optimization with Access Router Option”, IETF Internet Draft: draftng-nemo-access-router-option-01.txt, Expired Jan. 10, 2005.
Non Patent Citation 5: Ohnishi, H., Sakitani, K., and Takagi, Y., “HMIP based Route Optimization Method in Mobile Network”, IETF Internet Draft: draftohnishi-nemo-ro-hmip-00.txt, April 2003.

### DISCLOSURE OF INVENTION

From the operation of such heterogeneous protocols in a future scenario, it is clear that when the VMNs and MRs process ARO and MAP options, the muting of data packet is clearly sub-optimal. This can be clearly seen from the data messages 254 to 260 which show the data packet routing path from CN 71 to VMN 12. Such extreme routing sub-optimality occurs due to two reasons. One is due to the non-ideal binding cache entries at CN 71 when VMN 12 and MR 24 perform ARO type of registration at CN 71 using the RCoA. Since RCoA based BCE is formed at CN 71, every upstream MR's RCoA needs to be reached before reaching RCoA of VMN 12. This contributes to ping-pong routing. The second reason is due to the fact that a RCoA cannot be reached optimally due to non-ideal BCE and tracing mechanism at MAP. Ideal entries and mechanism at MAP mean all LCoAs of upstream MRs to reach a particular LCoA associated with a RCoA has to be present and be able to be traced at the MAP in a single tracing. Unfortunately, due to such ARO+MAP integration, such ideal entries are not formed at MAP 42 and also the MAP 42 implementing simple ARO type of tracing lacks such ideal tracing mechanism. From FIG. 2 it is clear that the data packet from CN 71 to VMN 12 is subject to ping-pong routing, to and forth from the MAP 42 and is further subject to multiple tunneling procedures. Similarly, the data packet from VMN 12 to CN 71 does not go through long winded routing but does go through multiple encapsulations as shown by messages 249 and 250. This clearly highlights the routing inefficiency problem when ARO+HMIPv6 protocols are implemented and operated in an environment where the MAP is ARO enabled and both ARO and MAP options are simultaneously processed by the mobile hosts and mobile routers.

FIG. 3 shows the routing problem in an ARO and HMIPv6 heterogeneous scenario, but in a deeper nesting environment with a CN that is simple MIPv6 type of node. In the scenario depicted in FIG. 3, VMN 12 is nested behind MR 24 and MR 25. MR 25 is directly attached to AR 34 and there is a single MAP in the hierarchy, which is MAP 43. The home agents of VMN 12, MR 24 and MR 25 are HA 58, HA 57 and HA 56 respectively. VMN 12 is having a data communication session with CN 72 which is MIPv6 enabled. It is further assumed that the VMN and MRs have ARO and HMIPv6 stacks implemented and also the MAP has ARO and HMIPv6 functionality implemented in it. It is further assumed that the home agents have ARO functionality implemented.

First, MR 25 comes into the network attached to AR 34 and gets the RA message 300. Following that, MR 25 will perform registration 301 at MAP 43. After the registration, the BCE at MAP 43 is given as 302. Following the registration at MAP 43, MR 25 will register with its home agent, which is HA 56. This registration message is given as 303. Following the message 303, the BCE at HA 56 is updated and given by 304. The messages from 300-327 are such that the full tunneling procedures and the full routing paths are not revealed in FIG. 3 to keep the explanation simple. Nevertheless, to one skilled in the art the exact routing paths and packet structures can be easily deduced. After MR 25 registers with HA 56, it will send a RA 305. This RA will have ARO option as well as the MAP option. MR 24 will then process the MAP option and ARO option and will start the ARO based BU registration at MAP 43. This is shown by message 306. This registration at MAP 43 will further update the BCE at MAP 43 and BCE will be as shown by 307. When MAP 43 sends the BA to MR 24, MR 25 will trigger RR and BU with the MAP 43 where it will attempt to do HoA, RCoA binding registration at MAP 53 using the ARO option in the BU. This registration is shown by message 308 and the updated BCE at MAP 43 is given by 309. It is important to understand that the BCE at MAP 43 has entries where the HoA column of the ARO table has true home addresses as well as RCoAs of mobile hosts and mobile routers. Furthermore, the LCoA column in the ARO table has true LCoAs as well as the RCoAs. Such heterogeneous addresses being injected into the ARO type BC entries are the root cause of the problem in such heterogeneous operation.

After registration at MAP 43, MR 24 will start ARO type registration at its home agent, which is HA 57. This ARO type BU is shown as message 310. The HA 57 BCE is shown by 311. Again it is important to see the BCE at HA 57 has only RCoA entries present. When HA 57 sends its BA to MR 24, MR 25 will kick of ARO type binding at HA 57. This is shown by message 312. After this message 312 reaches HA 57, the BCE entry at HA 57 will get further updated and is shown by 313. Once MR 24 does registration at its HA it will send a RA in its NEMO link. This RA message 314 will again have both ARO and MAP options available. When VMN 12 sees both such options, it will configure a RCoA and LCoA and then again carry out a ARO type registration at MAP 43. This registration message is shown as 315. After such registration, the BCE at MAP 43 will get further updated with VMN 12 entries and is shown by 316. When MAP 43 sends an acknowledgement to VMN 12 where the home address of MR 24 is embedded, MR 24 will start ARO type recursive signaling at the MAP 43 trying to register its HoA and RCoA. This recursive signaling is shown as 317. After this recursive signaling, the BCE at MAP 43 is further updated and is shown as 318. Since HoA of MR 25 registration is present at MAP 43, the MAP 43 will not embed the HoA of MR 25 in the response message (message 317) to MR 24. Incase MAP 43 embeds this HoA of MR 25, MR 25 need not send further send registration as it has already sent its HoA, RCoA registration to MAP 43 via message 308.

After registering with the MAP 43, VMN 12 will perform an ARO type of registration at its home agent which is HA 58. Once the registration message 319 reaches HA 58, the BCE gets updated and is shown as 320. It is important to note that the RCoA is registered there. Similarly MR 24 will perform a recursive ARO type of registration at HA 58 and this is shown by message 321. When HA 58 receives this message, the BCE gets further updated and the updated BCE is shown as 322. After a while, MR 25 will start recursive BU at HA 58 and the message is shown as 323. Once this message 323 has reached HA 58, the BCE will look like the one shown in 324. With the BCE 324, HA 58 can perform ARO type of tracing to reach the HoA of VMN 12. Nevertheless, the main problem is that all entries obtained from tracing for HoA of VMN 12 at HA 58 are the RCoAs, which will contribute to ping-pong routing.

After VMN 12 registers with its home agent, it will start ARO type of registration at CN 72. This registration message is shown as 325. Since CN 72 is simple MIPv6 type of node, CN 72 ignores the ARO option. Thus, after the BU at CN 72, the BCE at CN 72 will be as shown by 326. CN 72 will send a normal MIPv6 type of ACK. Thus the upstream MRs of VMN 12 will not further engage in any ARO type of recursive registration at CN 72.

Next, the data packet routing problem from CN 72, which is only MIPv6 node, is explained in detail. When CN 72 sends a data packet to VMN 12, it will set the destination address to RCoA of VMN 12 and the packet will have a RH2 where the HoA of VMN 12 will be embedded. MAP 43 will use the RCoA of VMN 12 to trace its BCE 318 using the ARO type of recursive tracing. When the MAP 43 looks for RCoA of VMN 12, it can find the entry and it will preferably get the associated care-of address into a temp structure. The first such obtained address is the LCoA of VMN 12. Next, the recursive ARO search mechanism will look at the value in the ARO field, which is HoA of MR 24. The recursive mechanism at MAP 43 will continue and will now use this address MR 24 HoA to further search the BCE 318. The search mechanism can readily find the entry and will get the RCoA of MR 24 into the temp variable. The search process will next get the HoA of MR 25 entry from the ARO field. The searching process will continue and HoA of MR 25 will be searched for. The search mechanism will then obtain the RCoA of MR 25 entry from the BCE. Since there are no ARO fields attached to this MR 25 HoA entry, the search stops here and the MAP 43 will encapsulate the CN 72 data packet in a single tunnel. This is shown as tunnel one in 330. This tunnel one will have RCoA of MR 25 as the destination address and the RH2 will have RCoA of MR 24 and LCoA of VMN 12 as shown in 330. The final entry in the RH2 will be RCoA of VMN 12. This is not explicitly shown in packet structure 330 but it is implicitly understood to one skilled in the art. The MAP 43 will next search its routing tables to find the route for RCoA of MR 25. It can find an entry for RCoA of MR 25 in its BCE and hence it will encapsulate the packet in another tunnel to LCoA of MR 25. This is shown as tunnel 2 in 330. This doubly encapsulated packet 329 will reach MR 25. MR 25 will remove the first tunnel and then look at the destination address in the inner tunnel. Since the inner tunnel destination address is RCoA of MR 25, it will next swap destination address with the next RH2 entry and place the RCoA of MR 24 as the destination address. Since MR 25 does not have a route to RCoA of MR 24, the packet will be further tunneled to the home agent of MR 25 and again tunneled to the MAP 43 at MR 25. These signaling are not revealed in the figure to keep explanation simple. Finally, this packet, which is destined to RCoA of MR 24, will reach MAP 43. Basically, the message 331 is such where further encapsulations and routing paths are not explicitly revealed in FIG. 3. The packet structure of the data packet when message 331 reaches MAP is shown as 332. When the packet 332 is inspected at the MAP 43, the search mechanism will search for RCoA of MR 24 entry at BCE 318. From this recursive ARO type search for RCoA of MR 24, LCoA of MR 24 and RCoA of MR 25 can be obtained.

MAP 43 will use these entries to construct the second tunnel. This second tunnel is shown as tunnel two in 334. Next the MAP 43 will look for routing entries to reach RCoA of MR 25, which is the destination address of tunnel two in packet 334. When inspecting MAP 43's BCE entry for RCoA of MR 25, the search mechanism can find such entry and will further encapsulate the packet in a third tunnel. This is shown as tunnel 3 in 334. This triply encapsulated packet will be sent to LCoA of MR 25 and is shown as message 333.

When MR 25 gets this packet 333, it will decapsulate the first tunnel and then swap the destination address to LCoA of MR 24. The packet 335 will be routed to LCoA of MR 24. When MR 24 gets this packet it will decapsulate the packet and set the destination address to LCoA of VMN 12. Finally the encapsulated packet 337 will reach VMN 12. For data traffic in the forward direction, one can clearly see the routing sub optimality involved. In this scenario, the BCE at CN 72 is ideal. It has only one entry, which is the RCoA of VMN 12 and it is a preferred entry. In this scenario, the sub optimality is mainly due to non-ideal entry and tracing mechanism at the MAP 43. The LCoA associated with the RCoA of VMN 12 and all the upstream MRs LCoAs were unable to be obtained using a single round of recursive ARO tracing. This is mainly due to the mixture of RCoA and LCoA entries in the care of address column of the ARO type BCE. Furthermore, the ARO type tracing mechanism is not intelligent enough to pick the relevant LCoA entries to reach a RCoA of VMN 12 from the total entries at the BCE.

Next, when VMN 12 sends the data packet to CN 72, it will set the source address to RCoA of VMN 12 and the destination address to CN 72 address. This packet will not have the NEMO-FWD option. This data packet will be further encapsulated in a tunnel to MAP 43. The tunnel packet will have source address set to LCoA of VMN 12 and the destination address will be MAP 43 address. This tunnel packet structure is shown by 340. The tunnel will have the NEMO-FWD option and the tunnel will also have the destination option, which will have the RCoA of VMN 12. When this singly encapsulated data message 339 reaches MR 24, it will be subjected to inspection at MR 24. MR 24 will inspect the NEMO-FWD option and hence change the source address of the tunnel to RCoA of MR 24. This is because MR 24 has used the RCoA to perform ARO type recursive binding at MAP 43. After performing such change, MR 24 will further encapsulate the packet in tunnel 2 to MAP 43. The tunnel 2 parameters are revealed using the packet structure 342. The tunnel 2 will also have the NEMO-FWD option. This doubly encapsulated message 341 will reach MR 25.

When MR 25 inspects this packet, it will again change the source address to RCoA of MR 25 and will further encapsulate the data packet in tunnel 3, which is shown by packet structure 344. This triply encapsulated data message 343 will reach MAP 43. The MAP 43 will decapsulate the packet and remove tunnel 3. To remove tunnel 2, the MAP will first do ARO type recursive tracing to reach RCoA of MR 24, which is in the Home Address Destination Option in tunnel 2. From the ARO tracing to reach RCoA of MR 24, MAP 43 can obtain the RCoA of MR 25 and hence it can successfully decapsulate tunnel 2. Similarly, MAP 43 can decapsulate tunnel 1 using similar ARO type of tracing and validation. Finally, the fully decapsulated packet will be sent to CN 72. In the reverse direction, the sub-optimal routing problem is smaller. There is no long winded routing but still there is routing sub-optimality due to very high encapsulations as discussed.

It is thus an objective of the present invention to overcome or at least substantially ameliorate the afore-mentioned disadvantages and shortcomings of the prior art. Specifically, the primary objective of the present invention is to provide a mechanism in an ARO and HMIPv6 heterogeneous scenario where VMNs and MRs both implement the ARO and HMIPv6 protocols and the MAPs implement the ARO and HMIPv6 protocols, so that the data packets between nested VMNs and CNs can be reached in a route optimized manner in a MAP domain.

In order to achieve the foregoing object, according to the present invention, the following systems, methods and apparatuses are provided.

The present invention provides a system of communications node comprising of VMNs, MRs, MAPs, HAs and CNs where it is considered that the VMNs, MRs and HAs have the ARO and HMIPv6 protocol implemented and the HA has the ARO protocol implemented. In this system, it is further considered that the router advertisement sent by the MRs will have two types of ARO options. One is the ARO option where MR's home address is sent and another is the ARO option where the MR sends its RCoA. The VMN and MRs use the ARO option with the RCoA for further processing in such an environment.

The present invention provides the method used in the above system where the VMN and MR use the RCoA value in its ARO option when registering with the MAP.

The present invention provides an apparatus used by VMN implementing the above system and method.

The present invention provides an apparatus used by MR implementing the method in the above system and method.

The present invention provides an apparatus used by MAP implementing the methods outlined in the above system and method.

The present invention provides a system of communications node comprising of VMNs, MRs, MAPs, HAs and CNs where it is considered that the VMNs, MRs and HAs have the ARO and HMIPv6 protocol implemented and the HA has the ARO protocol implemented. In this system it is further considered that the router advertisement sent by the MRs will have only a single type of ARO option where the ARO option defines the mobile access routers home address. In such an environment, when VMNs and MRs process both ARO and MAP options, using the entries of the BCE, the MAP does an intelligent tracing such that it can obtain the LCoAs associated with the VMN RCoA in a single level of tracing.

The present invention provides an apparatus of the MAP in the above system, implementing the intelligent tracing unit.

The present invention provides the method used by the MAP in the above system to do the tracing.

The present invention provides an alternate method used by the MR in the above system to do the address swap to LCoA instead to the RCoA when routing data packet in the reverse direction. MR will do such swap when it encounters the NEMO-FWD option.

The present invention provides the alternate method used by the MAP in the above system to de-tunnel the packet coming via the ingress interface. This method extends the intelligent tracing mechanism for the tunnel removal procedure.

The present invention has the advantage of providing a useful mechanism in an ARO and HMIPv6 heterogeneous environment.

### BRIEF DESCRIPTION OF THE DRAWINGS

FIG. 1 shows the network diagram of an ARO and HMIPv6 integration scenario when prior art protocols are deployed.

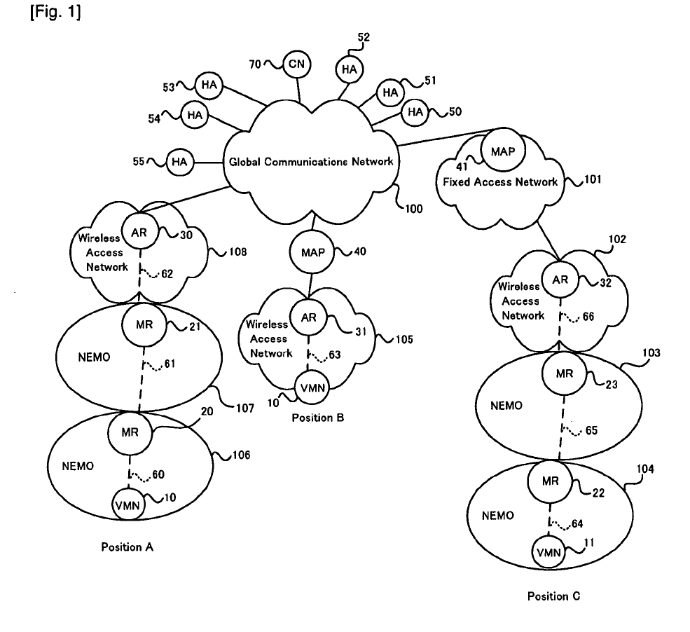

FIG. 2 shows the message sequence chart of the prior art operation when VMN, MR and MAP all implement the ARO and HMIPv6 protocols and the HA and CN implement the ARO protocol.

FIG. 3 shows the message sequence chart of the prior art operation when VMN, MR and MAP all implement the ARO and HMIPv6 protocols, HA implement the ARO protocol and the CN implement the MIPv6 protocol in a deeply nested scenario of VMN.

FIG. 4 shows the message sequence chart of the main invention where the method used is such that the MAP entries are updated using a special address in the ARO option according to a preferred embodiment of the present invention.

FIG. 5 shows the functional architecture of VMN implementing the main invention, which is disclosed in FIG. 4 according to a preferred embodiment of the present invention.

FIG. 6 shows the functional architecture of the MAP implementing the main invention disclosed in FIG. 4 according to a preferred embodiment of the present invention.

FIG. 7 shows the message sequence chart of the second variation of the main invention where an intelligent tracing unit at MAP enables to obtain optimal routing according to a preferred embodiment of the present invention.

FIG. 8 shows the functional architecture of the MAP implementing the second variation of the main invention where an intelligent tracing mechanism is designed at the MAP according to a preferred embodiment of the present invention.

FIG. 9 shows the flowchart of the operation of the MAP when implementing the second variation of the main invention according to a preferred embodiment of the present invention.

### BEST MODE FOR CARRYING OUT THE INVENTION

The present invention presents two methods to attain route optimization in an ARO and HMIPv6 integration scenario whereby the VMNs, MRs and MAPs have the ARO and HMIPv6 protocols implemented, the home agents have the ARO protocols implemented and the CNs either have ARO or MIPv6 protocol implemented and the VMN is preferably in a deep nesting scenario. The first method uses a modified ARO mechanism so that different parameters are used to populate the ARO related BCE at MAP so that an optimized route can be obtained from the above said CN and above said deeply nested VMN. The second method attains the optimal route without doing any changes to the ARO mechanisms in the terminals but using a deferred BCE tracing mechanism, which is different from standard ARO tracing mechanism.

In a first preferred embodiment, the main invention is disclosed. The main invention is such that the VMNs and the MRs use the RCoA of its mobile access router in the ARO option when they register at the MAP. In this heterogeneous environment where both ARO and MAP options are available, RCoA is used in the ARO option instead of the HoA of the mobile access router as in the conventional ARO mechanism, so that this can help in finding the relevant LCoAs to reach the RCoA of VMN, when standard ARO tracing is done at the MAP for the VMN RCoA. As far as the MAP registrations are concerned, MAP will update the home addresses column of its ARO registration table with the RCoA. Thus, the RCoA should be used in the ARO option column of the ARO registration table to trace the MAP efficiently as in standard ARO operation. To achieve this standard ARO tracing mechanism at the MAP, where the RCoA are placed in the home address column of the ARO registration table, the mobile terminals send binding registrations with the RCoA of the mobile access router in the ARO option.

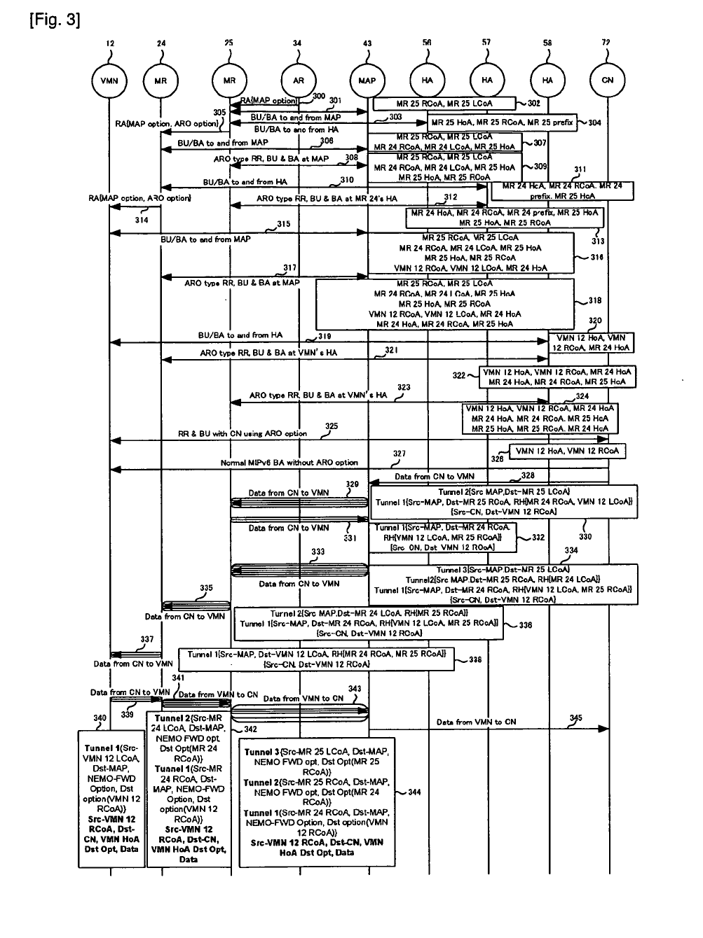

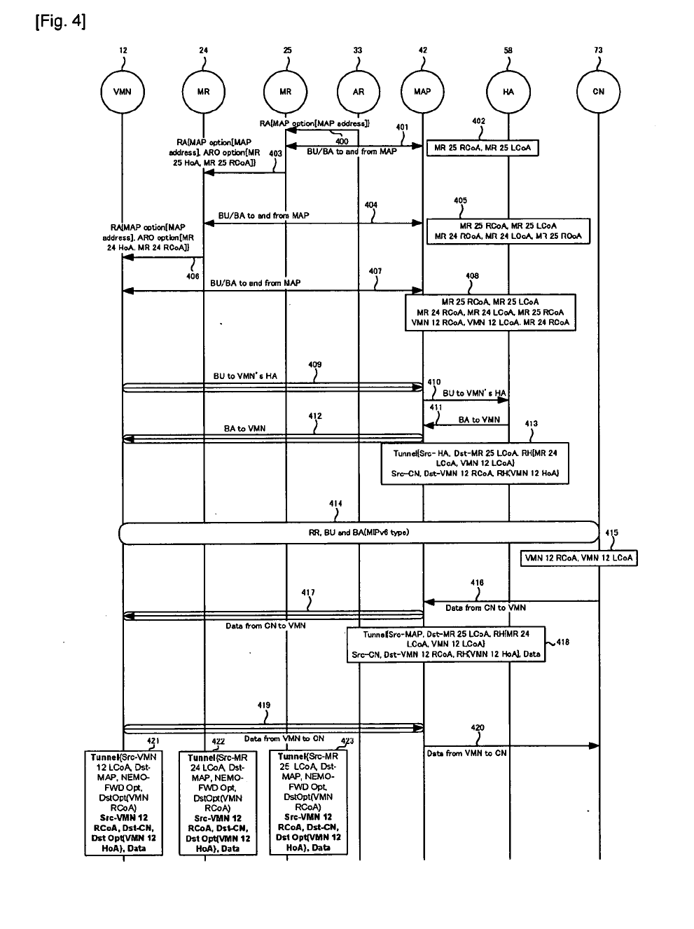

This is further explained by means of FIG. 4. In FIG. 4, VMN 12 is nested behind MR 24 and MR 25. MR 25 is directly attached to AR 33. There is only a single MAP in the access network and it is MAP 42. HA 58 is the home agent of VMN 12 and VMN 12 is having a data communication session with CN 73. To keep the description simple and not defer from the goal of presenting the core point of the invention, the home agents of the MRs are not explicitly given in FIG. 4. CN 73 is assumed to be ARO enabled. Again, it is assumed that VMN and MRs are ARO and HMIPv6 enabled and so is the MAP. Furthermore, it is assumed that HA is also ARO enabled, and that all mobile hosts and mobile routers process both ARO and MAP options when they receive RA from their access routers. The core point of this main invention is to make the BCE table ideal by populating the table with ideal entries. That is, the tracing for a RCoA of VMN should get LCoAs of all upstream MRs of VMN and LCoA of VMN in the correct order. From BCE table 318 in FIG. 3, it can be seen that such a goal of getting all the LCoAs cannot be achieved. In BCE 318, the first column of entries are the home address entries, the second column of entries are the care-of address entries and the third column of entries are the ARO option entries which will aid in recursive ARO tracing mechanism.

Currently the problem in the prior art lies in the fact that the home address of the mobile access router is sent in the ARO option during the BU registration at the MAP and as a result, normal recursive ARO BU registration originating from the mobile access router comprising of HoA and RCoA does take place. This recursive ARO registration takes place due to the MAP placing the HoA of MR in its ACK. MAP cannot find the HoA, which was sent in the ARO option, in its BCE, and hence will embed this in the ACK. This causes a mixture of RCoAs and LCoAs to be formed in the care of address column of the ARO table. The main invention prevents this from happening so that such recursive ARO update from upstream MRs does not take place further. This can be further explained by going through FIG. 4 message sequence in detail.

MR 25 receives the MAP option from RA 400. Once RA is received, MR 25 will configure RCoA and LCoA and will register at MAP 42 by means of message 401. After this registration, the BCE at MAP 42 is shown by 402. After that, MR 25 will broadcast its RA in its local NEMO network. This RA 403 comprises the MAP option and will have two ARO options attached. The first ARO option is the home address of MR 25 and the other is the RCoA of MR 25. The main invention is such that, in this heterogeneous environment where the MAP is ARO enabled, the MRs will send two ARO options in their RA. Whether the MAP is ARO enabled or not can be obtained by some reserved field in the MAP option.

When MR 24 receives this RA 403, it will use the RCoA of MR 25 as the ARO option when it binds with MAP 42. After receiving RA 403, MR 24 will register with MAP 42 with a registration message 404. This registration message is encapsulated by MR 25 before reaching MAP 42. This causes MAP 42 BCE to be updated further and the BCE is shown by 405. The MAP 42 will now inspect the ARO option field in the BU, which is the RCoA of MR 25. Since it already has a binding for this address, MAP 42 will not send this value when sending BA to MR 24. It can be appreciated by one skilled in the art that the care-of address entries in 405 are all local care-of addresses and there is no mixture of RCoAs and LCoAs in this column.

Once MR 24 has successfully registered at MAP 42, it will send out its RA 406 again comprising of MAP option and two types of ARO options. VMN 12 will receive all these options and again process MAP option and the ARO option comprising the RCoA of MR 24. After configuring the care-of addresses, VMN 12 will carry out a registration at MAP 42, which is shown by the message 407. Following this registration, the BCE at MAP 42 will be further updated and is given by 408. Next, VMN 12 will want to register with its HA which is HA 58. The BU to HA 58 will be of normal MIPv6 type without ARO option. The VMN 12 will use simple HMIPv6 processing to perform such registration at HA 58. This is a change in the method although the VMN 12 processes both MAP and ARO options. The registration message is given by 409. This message will be tunneled at VMN 12. Once HA 58 successfully processes this registration 409, it will send a response message 411. This is a BA message, which will be intercepted by MAP 42 and tunneled to VMN 12. The packet structure of the BA before being further routed at MAP 42 is shown by 413. MAP 42 will use ARO recursive search mechanism to look for RCoA of VMN 12. It will use the BCE 408. After the search, the MAP 42 will get the addresses such as LCoA of VMN 12, LCoA of MR 24 and LCoA of MR 25. Reversing these address order, the MAP 42 can construct the ideal tunnel eliminating all ping-pong routing. This tunneled BA message 412 will reach VMN 12.

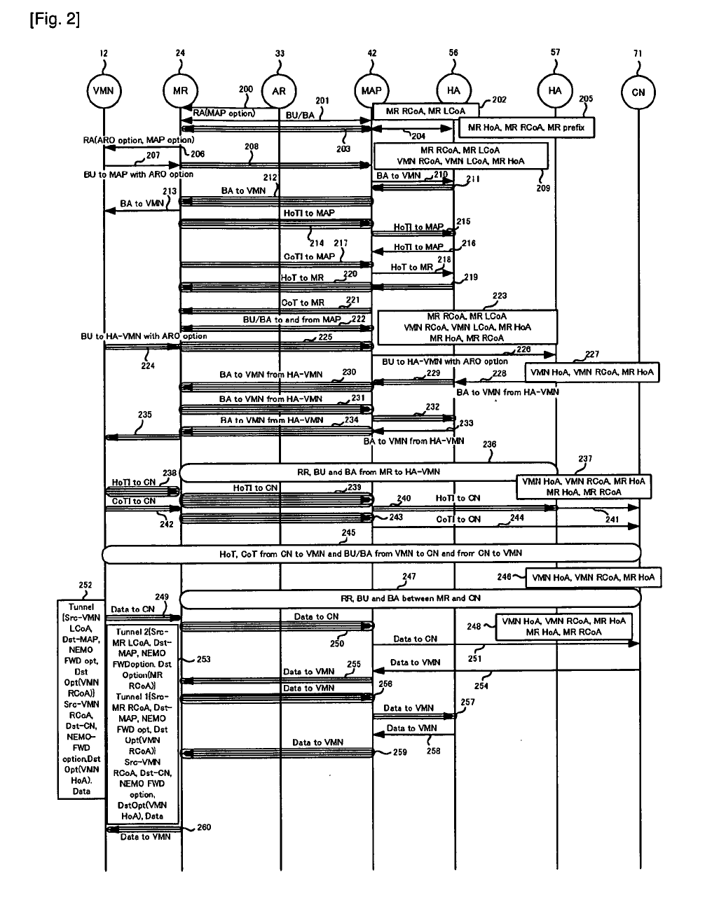

Following the registration at HA 58, VMN 12 will start binding with CN 73. As explained in the prior art scenario disclosed in FIG. 2, when ARO is done at a CN using RCoA, excessive routing sub-optimality occurs. This main invention prevents this and normal HMIPv6 type registration is done with CN 73 and this is shown by the message 414. After this registration, the BCE at CN 73 will look like the one shown by 415. Note that there is no ARO field in the BCE 415. Next, CN 73 starts sending data packet to VMN 12. The destination address of this data packet will be RCoA of VMN 12. This data message is shown by message 416. This message will be further encapsulated at MAP 42 and the encapsulated packet structure is given by 418. The MAP 42 can easily get the LCoAs in a single ARO type of recursive tracing. To one skilled in the art it is easy to appreciate how by means of RCoA based ARO option, the BCE entries at MAP 42 are made more ideal. The encapsulated message 417 will finally reach VMN 12. Thus, when compared to prior art routing problem explained in FIG. 2 and FIG. 3, this main invention has achieved a much more optimized route in this scenario. Moreover, not only optimized routing, this method has achieved location management efficiency as well. The only inefficiency involved is that the RA needs to send two types of ARO options, which consume some wireless bandwidth.

Next, VMN 12 may wish to send data to CN 73. VMN 12 will construct the data packet where the source address will be RCoA of VMN 12 and destination address will be CN 73 address. VMN 12 will encapsulate this packet in a tunnel to MAP 42. Since VMN 12 has an ARO type BU at the MAP 42, it will insert the NEMO-FWD option into the tunnel. The packet structure is shown by 421. The tunnel will also have the RCoA of VMN 12 as the home address destination option. When MR 24 receives this encapsulated message 419, it will process the NEMO-FWD option and will simply change the source address to LCoA of MR 24. Again, some change is required in MR to do this. Although it has not done any ARO type of recursive binding at MAP 42, it needs to perform this source address change. The packet structure at MR 24 after such source address change is shown by 422. When MR 25 processes this packet, it will change the source address of the tunnel to its LCoA. The packet structure at MR 25 is shown by 423. Finally, when the MAP 42 receives this packet, it will do a recursive tracing using RCoA of VMN 12 and see whether LCoA of MR 25 can be obtained. Since tracing mechanism of MAP 42 using the new inventive cache 408 can obtain LCoA of MR 25 and this matches with tunnel source address, MAP 42 can successfully remove tunneling and route the packet to CN 73. This decapsulated data message to CN 73 is shown by message 420.

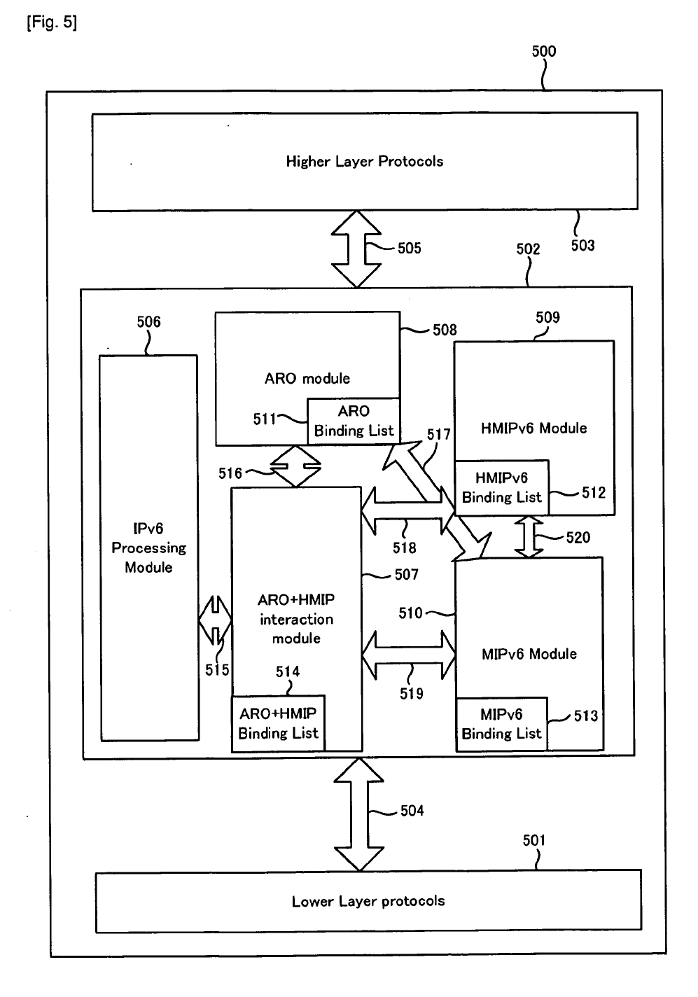

In another preferred embodiment of the present invention, the functional architecture of Mobile Host (VMN) implementing the main invention disclosed in FIG. 4 is given. FIG. 5 shows the preferred functional architecture 500 of VMN 12 in FIG. 4. The functional architecture 500 comprises of lower layer protocol module 501 comprising of all the software and hardware required to implement lower layer protocol functionality such as the physical layer, media access control layer and the data link layer. The functional architecture 500, further comprises of a routing layer 502. This routing layer comprises of all the software and hardware required to perform routing as outlined in the main invention disclosed in FIG. 4. The top most layer in 500 comprises of higher layer protocols 503. This consists of all the software and hardware required to implement transport, session and application protocols.

The routing layer 502 further comprises of IPv6 processing module 506, ARO module 508, HMIPv6 module 509, MIPv6 module 510 and the new inventive module ARO+HMIP interaction module 507. The IPv6 processing module 506 is responsible for processing RA, doing link local routing, sending and processing ICMPv6 messages, IPv6 header formation, address configuration and so forth. The ARO module 508 has all the functionality to implement a pure ARO mechanism. Along with the ARO module there is attached an ARO Binding list 511. This list is updated when pure ARO operation takes place. Such an operation takes place when the VMN does not process the MAP option nor the RCoA based ARO option field. The ARO Binding list 511 will have entries of the CN and the ARO parameters used to establish pure ARO with a CN.

The HMIPv6 module 509 implements all the functionality of the standard HMIPv6 protocol. This functionality is used when the VMN only process the MAP option. Such an event can occur when VMN's access router is not ARO enabled or it is some policy setting at VMN to do so. Again, along with the HMIPv6 module 509 there is an attached HMIPv6 binding list 512. This list has all the registrations VMN makes with a CN using the pure HMIPv6 stack. Such pure HMIPv6 stack operation can take place when there are no ARO options received from the RA and only the MAP option is received. MIPv6 module 510 shows the MIPV6 implementation at VMN. Pure activation of module 510 is useful in a scenario where no ARO or MAP options are available. Furthermore, the codes in this module 510 are useful when the VMN does not want to do ARO with the CN as explained in the main invention and also it is useful for registration mechanism associated with HMIPv6. Again, the MIPv6 module 510 has a binding list 513 associated with it. This binding list will have all the CN entries and registration parameters used by VMN to do simple MIPv6 registration with the CNs.

The new module that functions as the central coordinator in this ARO and HMIPv6 heterogeneous scenario is shown as 507. It also has a binding list associated with it and is called ARO+HMIP Binding list 514. The Binding list 514 will have all CN registrations and MAP registrations when both ARO and MAP options are processed by VMN. The module 507 is more active in a heterogeneous ARO and HMIPv6 scenario. Nevertheless, in other scenarios also it is active to a certain extent, as it will decide on which stack to trigger at any one time. Basically it behaves as an intelligent unit and may decide on suitable processing depending on the needs of the flows carried in VMN. Before explaining the details of this module 507 and how it interacts with other modules, the interfaces are next explained. The lower layer protocol module 501 will communicate with routing layer module 502 by means of the interface 504. This interface is used to pass all the data packets and control packets between routing layer 502 and lower layer 501. The routing layer 502 and higher layer 503 communicate via the interface 505. This interface is used to send the data packets to and forth between the routing layer 502 and higher layer 503.

The IPv6 processing module 506 will communicate with the ARO+HMIP interaction module 507 by means of the interface 515. The ARO+HMIP interaction module 507 will communicate with MIPv6 module 510, HMIPv6 module 509 and ARO module 508 by using interfaces 519, 518 and 516 respectively. MIPv6 module 510 and HMIPv6 module 509 will communicate with each other using the interface 520. Similarly, MIPv6 module 510 will communicate with ARO module 508 using the interface 517. It can be easily understood by one skilled in the art as to why such interfaces 520 and 517 exist. Since HMIPv6 and ARO are derived functions of basic MIPv6 protocol, it is quite obvious such functional architecture with interfaces 520 and 517 exist.

The ARO+HMIP module 507 acts as the core functionality. It is responsible for processing the RA options. These options may preferably be passed from the IPv6 routing module 506 by means of the interface 515. The ARO+HMIP module 507 will monitor the options and decide which module needs to be triggered or whether multiple modules need to be triggered. If ARO and MAP options are available, the interaction module 507 will communicate with ARO and HMIPv6 modules and do the necessary processing as outlined in the main invention that was explained previously.

In yet another preferred embodiment of the present invention, the mobile router functional architecture implementing the main invention disclosed in FIG. 4 is explained. The MR 24 and MR 25 in FIG. 4 will have almost identical architecture and functionality as explained in FIG. 5. The only difference is that, in addition to all the modules given in FIG. 5, the MRs will also have a NEMO Basic module. The ARO module will have interaction to this NEMO Basic module and the ARO+HMIP module will also have interaction to this NEMO Basic module. Moreover, the ARO+HMIP module in the MR may preferably have a mechanism to decide as to when to send its RCoA as another ARO option in its RA.

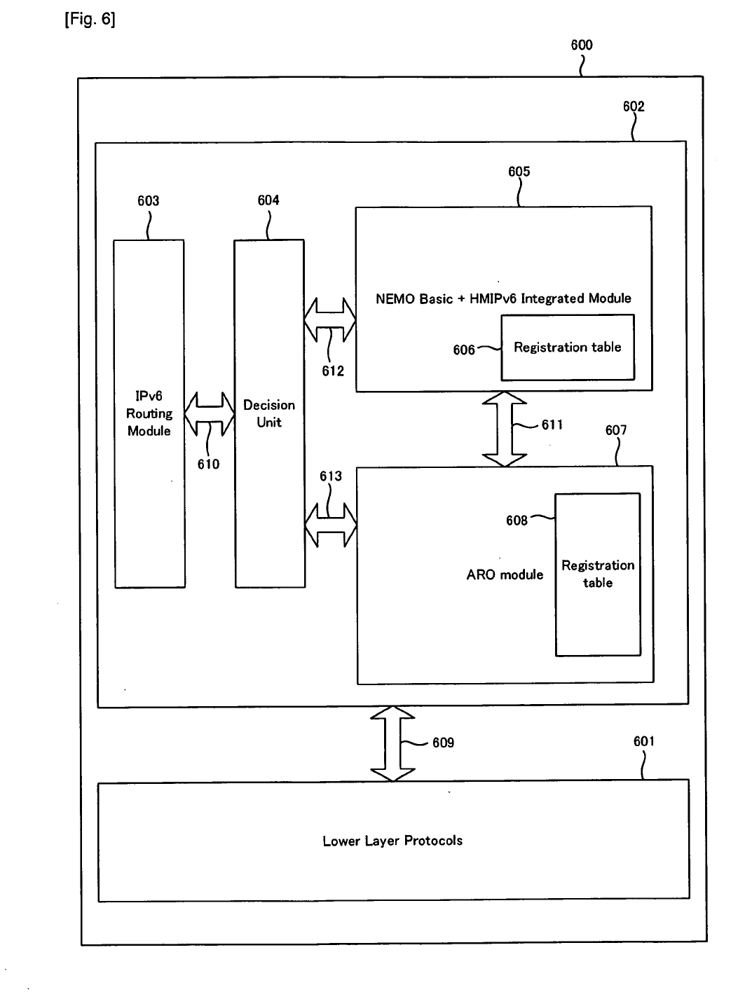

In a further preferred embodiment of the present invention, the MAP functional architecture implementing the main invention disclosed in FIG. 4 is explained. The MAP 42 in FIG. 4 may preferably have a functional architecture as described in FIG. 6. The MAP functional architecture is given by 600 in FIG. 6. This architecture 600 consists of all software and hardware required to perform MAP functionality as disclosed in the main invention, which was explained via FIG. 4. Since MAP is primarily a router, it only has lower and middle layer protocols implemented in it. Again, the lower layer protocols 601 comprise of software and hardware required to implement physical layer, media access control layer and data link layer functionalities. The routing layer 602 consists of heterogeneous routing modules and binding cache entry tables. The routing layer 602 communicates with lower layer protocols 601 by using the interface 609. This interface 609 is used to pass the data and control packets between layers 601 and 602.

The routing layer 602 further comprises of four main routing functional modules. They are the IPv6 routing module 603, the Decision unit 604, the NEMO Basic and HMIPv6 integrated module 605 and the ARO module 607. The ARO module 607 has an attached binding cache table called the registration table 608 and the NEMO basic and HMIPv6 integration module 605 also has a binding cache entry table again called the registration table 606. It can be well understood for one skilled in the art that the MAP implementing the main invention need not have many changes done to its architecture. Nevertheless, a new decision unit 604 is incorporated into the architecture to make the processing and organizing simple. IPv6 routing associated with module 603 deals with all link local type of routing and also routing via the default routers as specified in standard IPv6 routing operations. The ARO module 607 deals with all ARO type registration acceptance decisions as well as tracing for a particular RCoA when a packet comes at the ingress and egress interface of the MAP and this RCoA is registered at its associated table 608. The BCE 608 in the ARO module consists of entries that are populated when the nodes in the MAP domain process both ARO and MAP options and make the appropriate registration at the MAP. The NEMO basic and HMIPv6 integration module 605 is basically similar to standard HMIPv6 MAP functional module. The NEMO basic codes or functionality is integrated into this module so that the MAP can accept PSBU type registrations and process them if required.

The core function of the decision unit 604 is to decide which module has to be triggered after inspecting a packet passed from module 603. If the registration has an ARO option, then the decision unit 604 will pass the registration packet to ARO module 607 else it will pass it to module 605. In some cases, the registration from table 606 will eventually be passed to table 608. For example, the registration from the top level mobile router may initially be passed to the registration table 606 and may be passed back to ARO module 607. The interaction between the IPv6 routing module 603 and the decision module 604 will preferably take place using the interface 610. The interaction between modules 605, 607 and the decision module 604 will preferably take place via the interfaces 612 and 613 respectively. In FIG. 6, there is an interface between the HMIPv6 module 605 and ARO module 607. Currently this interface is not used much, but can be used in a future evolved system for fast communication between modules.

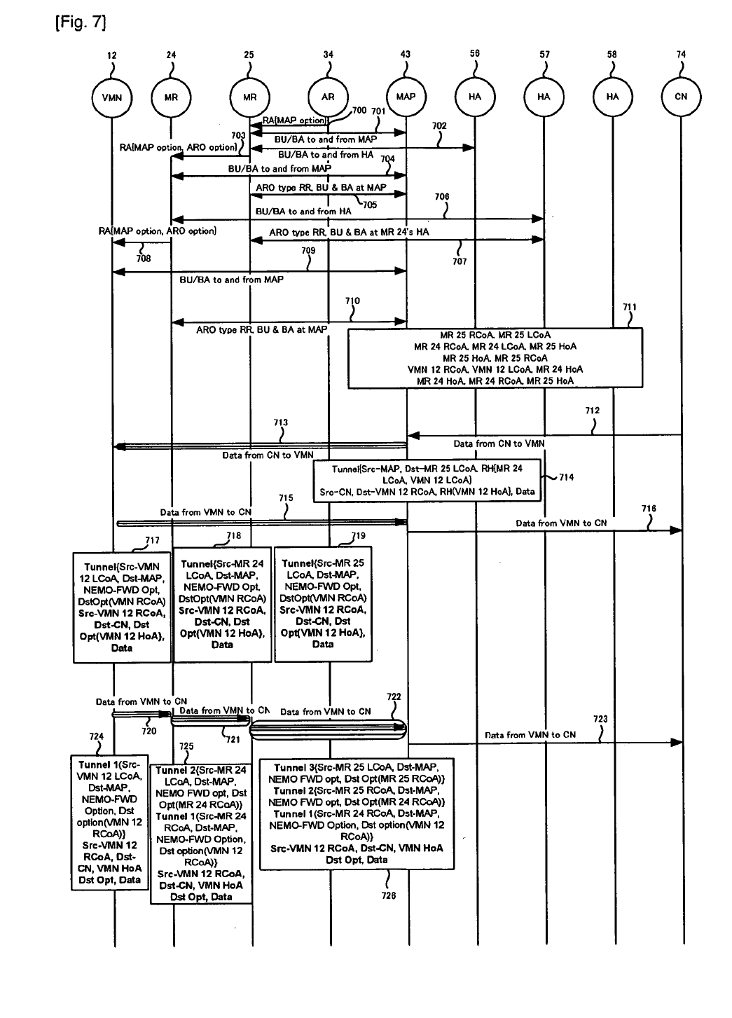

In another preferred embodiment of the present invention, there is provided a method where route optimization between a VMN and a CN is achieved in such a heterogeneous HMIPv6 and ARO scenario without doing any changes to mobile terminals or mobile routers. Instead, modification is applied to the MAP functionality. Again, it is assumed that the VMNs, MRs and MAPs implement both ARO and HMIPv6 functionality. In addition, it is assumed the VMNs and MRs process both ARO and MAP options, and that the HAs are ARO enabled. Basically, an intelligent tracing mechanism is designed and implemented at the MAP so that the MAP can use a tracing mechanism different from standard ARO tracing to get all the LCoAs required to reach VMN RCoA optimally preferably via a single tunnel by means of a single recursive search. All this is obtained without any modification to standard ARO or HMIPv6 operation in the system. This method is further described by means of the message sequence chart that is given in FIG. 7.

In FIG. 7, VMN 12 is nested behind MR 24 and MR 25. MR 25 is directly attached to AR 34. There is only one MAP in the architecture and it is MAP 43. The home agents of VMN 12, MR 24 and MR 25 are HA 58, HA 57 and HA 56 respectively. In this FIG. 7, all signaling are not explicitly revealed. For a detailed signaling description one can look at FIG. 3 that explains a similar scenario. MR 25 receives a RA 700 from AR 34. This RA will only have the MAP option. MR 25 will then derive the RCoA and LCoA and then register at MAP 43. This registration message 701 is shown in FIG. 7. After such registration, MR 25 will register with its HA 56 using the registration message 702, where the tunneling procedure and routing paths not fully revealed in the figure. Again, MR 25 will send out a RA 703 where MAP option and ARO option will be sent. There will be only one ARO option, and the value will be the MR 25 HoA. After receiving both options, MR 24 will process both options and will send an ARO type of registration at MAP 43. This is shown by the message 704, where the tunneling procedure and routing paths not fully revealed in the figure.

When the MR 25 receives an ACK from MAP 43 where MR 25's HoA is embedded, MR 25 will do ARO recursive type of registration with MAP where MR 25 registers its HoA and RCoA. This recursive registration is shown by message 705. After registering with the MAP 43, MR 24 will register with its HA 57. This is again shown by the message 706, where the tunneling procedure and routing paths not fully revealed in the figure. Again due to MR 25's HoA embedded in the ACK sent from HA 57, MR 25 will do ARO type of recursive registration at the MAP. This recursive message is shown by 707. To eliminate routing inefficiencies the MR and VMN when communicating with their HAs and CNs need not use ARO option. Such a method was used in the main invention disclosed in FIG. 4. Similar mechanism can also be used in this variation of the main invention.

After binding registration with HA 57, MR 24 will send a RA message 708. Again, both ARO and MAP options are processed by VMN 12. VMN 12 will then start registration with the MAP 43 using ARO option. This message is shown as 709, where the tunneling procedure and routing paths not fully revealed in the figure. The ARO option value is the HoA of MR 24. Since the MAP 43 does not have an entry for HoA of MR 24 it will send this value embedded in the ACK to VMN 12. This will cause MR 24 to do ARO type recursive binding at MAP 43 registering its HoA and RCoA at MAP 43. This message is given as 710, where the tunneling procedure and routing paths not fully revealed in the figure. Finally, the BCE at MAP 43 will look like the one given in 711. When one skilled in the art takes a deep look at this BCE, it is evident that all the LCoAs to reach RCoA of VMN 12 are present in this cache and all that is required is a more sophisticated tracing at the MAP 43.

After such registration, the VMN 12 will register with CN 74. It is considered that VMN 12 will merely perform a HMIPv6 type of registration at the CN 74. Thus the RCoA of VMN 12 and HoA of VMN 12 will be registered there. This registration is not shown in FIG. 7. CN 74 will then send the data packet to VMN 12 and this is shown by message 712. The MAP 43 will intercept this packet and then use an intelligent tracing to get the required LCoAs to reach RCoA of VMN 12. The intelligent tracing is such that an ARO type of recursive tracing is carried out first. For example when the MAP 43 does such ARO type of tracing for the RCoA of VMN 12, the addresses obtained will be LCoA of VMN 12, RCoA of MR 24 and RCoA of MR 25. After such basic tracing, the MAP will further check whether such obtained entries are found in the first or HoA column of the ARO binding cache. If it is found, then it will further look at the care-of address associated with the RCoA and then swap the RCoA with the relevant LCoA obtained. For example, when BCE 711 is traced after ARO tracing, the intelligent search mechanism can find entries for RCoA of MR 24 and RCoA of MR 25.

The intelligent tracing will then get the LCoA of MR 24 and LCoA of MR 25 and construct the tunnel structure using LCoA of MR 25 as the destination address and the LCoA of MR 24, LCoA of VMN 12 and RCoA of VMN 12 as RH2 contents. This is shown by packet structure 714. Finally, the singly encapsulated data message 713 will reach VMN 12. It can be seen that, by merely using the entries in the MAP 43, an optimized route in the forward direction was obtained by using some intelligent tracing at MAP 43. When VMN 12 sends data packet to CN 74, again VMN 12 will construct the packet where the source address will be VMN 12 RCoA and the destination address will be the address of CN 74. The packet will be encapsulated in a tunnel to MAP 43 and this packet structure will be as given by 717. The source address of the tunnel will be LCoA of VMN 12 and the destination address is the address of MAP 43. When MR 24 gets this message 715 it will also look at the NEMO-FWD option.

Ideally, MR need not have any change in its functionality in this second variation of the invention and should change the source address to its RCoA as explained in the prior art scenario in FIG. 3. Nevertheless, the MR may preferably do a slight change to its implementation and instead put its LCoA there. This further improves the performance from the prior art scenario described in FIG. 3. With such slight change in MR functionality, the packet structure at MR 24 is given by 718. Again this packet will reach MR 25 where MR 25 will also change the source address to LCoA of MR 25. Finally, MAP 43 will do the de-tunneling. Here, MAP 43 needs to see whether it can obtain LCoA of MR 25 when it does the tracing for RCoA of VMN 12 attached as the home address destination option in the tunnel. By using the intelligent tracing mechanism previously described, the MAP 43 can obtain this and it can readily validate the tunnel and remove the tunnel successfully and further route the data packet to CN 74. This message being further routed from MAP 43 without any tunneling is shown as 716. In an alternate way, when this intelligent tracing facility is deployed without any changes to MR, optimized route between VMN 12 and CN 74 can be obtained in the reverse direction. These messages are shown by 720, 721, 722 and 723. In such a case, the MAP 43 should perform normal ARO tracing to validate the tunnels and remove the tunnels. It need not do intelligent tracing for tunnel removal. The detail of the packet structure is identical to that explained in the prior art scenario disclosed in FIG. 3 and thus will not be explained any further. The packet structures 724, 725 and 726 are identical to those given by 340, 342 and 344 in FIG. 3 respectively.

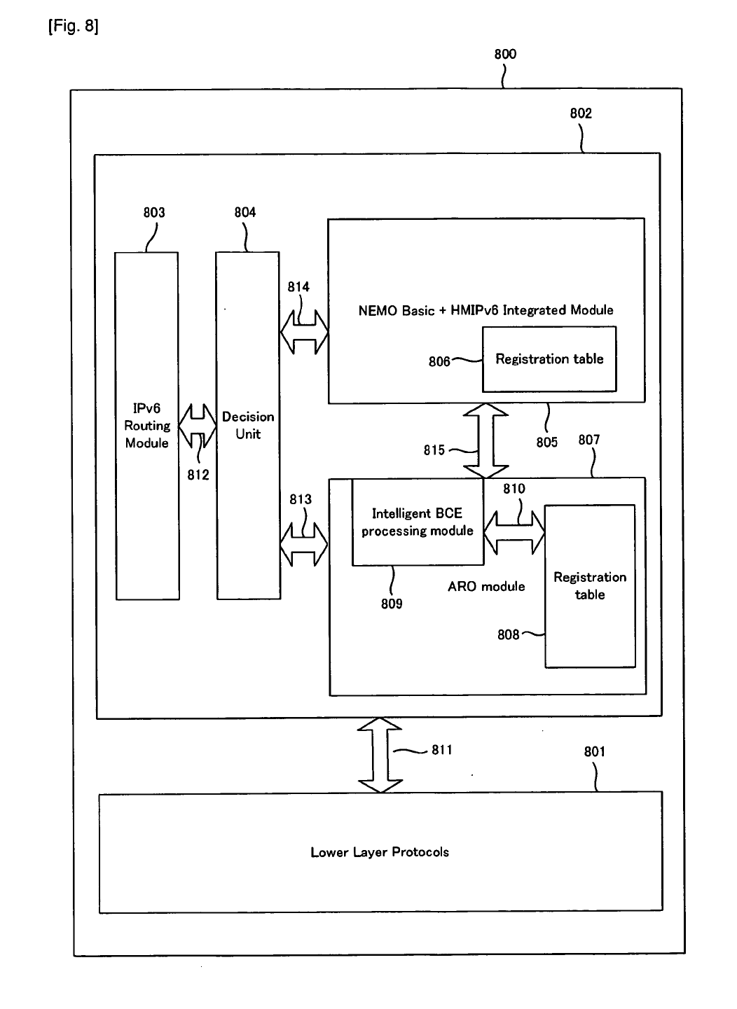

In the second variation of the main invention, the main change is done at the MAP. Thus the MAP needs some new functionality that is different from FIG. 6. The new MAP functionality implementing the second variation of the main invention disclosed in FIG. 7 is given by FIG. 8. In FIG. 8, 800 gives the functional architecture of this sophisticated MAP. It comprises of lower layer protocol module 801 and routing layer module 802. The routing layer module 802 further comprises of the IPv6 routing module 803, decision unit 804, ARO module 807 and the NEMO and HMIPv6 integration module 805. These modules communicate with each other using the interfaces 811, 812, 813, 814 and 815. The NEMO Basic and HMIPv6 integration module 805 has a registration unit 806 and the ARO module 807 has a registration unit 808. The functionality of these modules and the interfaces are identical to that discussed in FIG. 6 detail explanation. The only new unit is the intelligent processing unit 809 that is implemented inside the ARO module 807. This unit 809 uses the ARO search result and further queries the registration table 808 to get the LCoA entries. Basically the intelligent tracing unit will look at the entries obtained from ARO search. It will check whether a particular ARO search entry is a RCoA or LCoA. If it is a RCoA, unit 809 will look at home address column of ARO registration table 808 and get the relevant LCoA and will swap the RCoA value from the ARO search with obtained LCoA value. Whether the address is RCoA can be determined from the prefix or by looking at the table 808 and checking whether these entries are present in the home address column of the ARO table. In summary, all that the intelligent unit 809 does is to look at 808 and swap the RCoA with its LCoA value.

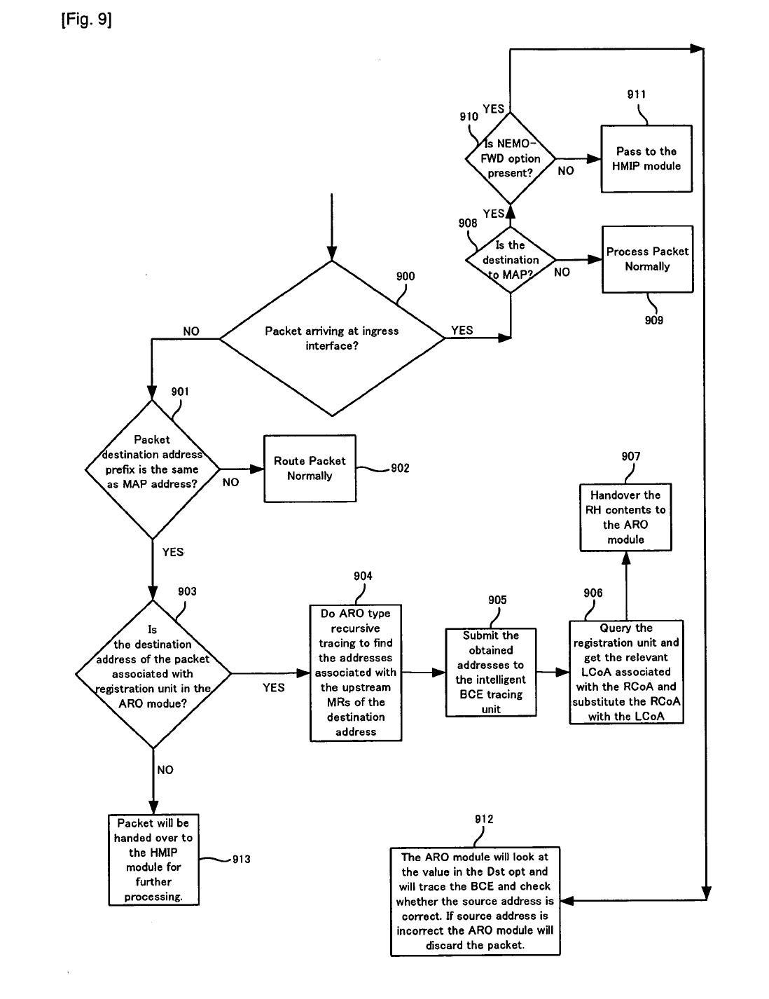

In another preferred embodiment of the present invention, the operation of the MAP 43 in FIG. 7 is further explained by means of a flow chart, which is given in FIG. 9. When the packet arrives at the MAP 43, by performing step 900 it is first checked whether the packet arrives at the ingress or egress interface. If the packet arrives via the egress interface, then the step 901 is performed. This step checks whether the destination address prefix is the same as the MAP's address prefix. If step 901 evaluates to false, then step 902 is performed and the packet is routed normally using the IPv6 routing mechanism as given by 803 in FIG. 8. If the destination address prefix is the same, as MAP address prefix then the step 903 will be performed. The step 903 checks whether the packet destination address belongs to the registration unit 808 in the ARO module. Such checks can be done by the decision unit 804. If step 903 evaluates to false, then the packet will be sent to HMIP unit 805 via the interface 814. If the step 903 evaluates to true, then the packet will be passed to the ARO module 807. After that, the first step will be 904 where ARO type recursive tracing will be carried out. Following the basic ARO tracing step, step 905 will be performed where the search contents from ARO tracing is passed to the intelligent tracing unit 809. The step that is performed in the intelligent tracing unit is given as 906. The step 906 does the RCoA to LCoA swap. After this swapping, the intelligent tracing unit passes the contents back to ARO module for RH2 construction. This is shown by the step 907.

Suppose at step 900, the packet arrives at the ingress interface, then the step 908 will be performed. The step 908 checks whether the destination address is the MAP. If step 908 evaluates to false, the packet is processed by IPv6 Routing Module 803 and such processing is given by step 909. If 908 evaluate to true, step 910 is performed where it is checked whether the NEMO-FWD option is present. If it evaluates to false then the step 911 is performed and the packet is handed over to HMIPv6 module 805. If 910 evaluate to true then the step 912 is performed. This processing is done by ARO module 807. This step 912 is the validated tunnel removal procedure, which is used by the ARO mechanism.

Although the invention has been herein shown and described in what is conceived to be the most practical and preferred embodiment, it will be appreciated by those skilled in the art that various modifications may be made in details of design and parameters without departing from the scope and ambit of the invention. For instance, the present invention uses ARO scheme as the route optimization mechanism used in nested mobile networks. It should be appreciated by a person skilled in the art that the present invention can be applied to other route optimization mechanism as well, such as one that uses mobile router's address in some way to achieve route optimization. In addition, the present invention uses HMIPv6 as the local mobility management protocol. It should be appreciated by a person skilled in the art that the present invention can be applied to other local mobility management protocols as well.

### INDUSTRIAL APPLICABILITY

The present invention has the advantage of providing a useful mechanism in an ARO and HMIPv6 heterogeneous environment, and can be applied to the field of packet-switched communication.

1-10. (canceled)

11. A system of communications node comprising VMNs, MRs, MAPs, HAs and CNs wherein the VMNs, MRs and MAPs have an ARO and HMIPv6 protocol implemented and the HA has an ARO protocol implemented, wherein a router advertisement sent by the MRs will have two types of ARO options, one type of the ARO options being an ARO option with MR's home address embedded and another type of the ARO options being an ARO option with MR's RCoA embedded, and wherein the VMN, MAP and MRs use an ARO option with the RCoA for further processing.

12. The system according to claim 11 wherein the VMN and MR use a value of the RCoA in its ARO option when registering with the MAP.

13. An apparatus used by the VMN defined in claim 11.

14. An apparatus used by the MR defined in claim 11.

15. An apparatus used by the MAP defined in claim 1 wherein a tracing to identify the LCoAs is performed to reach a given RCoA based on the ARO option entry in BCE.

16. A system of communications node comprising VMNs, MRs, MAPs, HAs and CNs wherein the VMNs, MRs and MAPs have an ARO and HMIPv6 protocol implemented and the HA has an ARO protocol implemented, wherein a router advertisement sent by the MRs will have only a single type of ARO option, this type of ARO option defining a mobile access router's home address, and wherein, the VMNs and MRs process both ARO and MAP options, using entries of BCE, the MAP does an intelligent tracing such that it can obtain LCoAs associated with the VMN's RCoA in a single level of tracing.

17. An apparatus used by the MAP defined in claim 16 wherein the MAP implements an intelligent tracing unit for doing the intelligent tracing.

18. A method used by the MAP defined in claim 16 to do the intelligent tracing, comprising the steps of:
verifying whether an address obtained in tracing using ARO method is a RCoA or LCoA; and
identifying the LCoA corresponding to RCoA from the BCE when the address obtained using ARO method is RCoA.

19. A method used by the MR defined in claim 16 to do an address swap to LCoA instead to the RCoA when routing data packet in a reverse direction, wherein the MR will do the address swap when it encounters a NEMO-FWD option.

20. A method used by the MAP defined in claim 16 to de-tunnel a packet coming via an ingress interface of the MAP, whereby a mechanism of the intelligent tracing can be extended for a tunnel removal procedure.
